(19) United States
(12) Patent Application Publication
(10) Pub. No.: US 2007/0125386 A1
(43) Pub. Date: Jun. 7, 2007

(54) Pliant clip for attaching a strap to a mask

(75) Inventor: Brad Quinn, Indianapolis, IN (US)

Correspondence Address: SWANSON & BRATSCHUN L.L.C., 1745 SHEA CENTER DRIVE, SUITE 330, HIGHLANDS RANCH, CO, 80129, US

(73) Assignee: Engineered Medical Systems, Inc., Indianapolis, IN (US)

(21) Appl. No.: 11/293,405

(22) Filed: Dec. 2, 2005

(51) Int. Cl. A62B 18/08; E04G 7/18

(52) U.S. Cl. 128/207.11; 403/399; 403/404

(57) ABSTRACT

A clip for receiving a post. The clip includes a body defining a hole having a diameter less than a select cross-section of the post. The body of the clip is made of a material which is sufficiently pliant to provide for the deformation of the hole to receive the post upon attachment of the clip to the post. Another aspect of the present invention is a gas transmission mask including a post and a clip as described above for attaching a strap to the mask. The post may have a shaft and a head with a cross-sectional dimension of the head being greater than a cross-sectional dimension of the shaft. In addition, the hole may be substantially cylindrical. In this embodiment, the lengthwise axis of the cylindrical hole may be substantially equal in length to the length of the shaft. The pliant body of the clip of the present invention may be made of a pliant thermoplastic such as synthetic rubber, silicone, thermoplastic resin, natural rubber or polyvinylchloride. The pliant body of the clip may be made of a material having a hardness of between 20-80 on the Shore “A” durometer scale.

### TECHNICAL FIELD

The present invention is directed toward a clip for attaching a strap to a mask, and more particularly to a pliant clip for attaching one or more straps to a gas transmission mask.

### BACKGROUND OF THE INVENTION

Several types of masks are commonly used to deliver air, oxygen, anesthesia or other gasses to or from a human patient's respiratory system. These masks are typically sized to fit over a patient's nose, nose and mouth or full face. Masks are commonly used for emergency care, emergency transport, critical hospital care or home health care. All types of masks designed to deliver a gas to or from a patient's respiratory system are collectively referred to herein as gas transmission masks.

Many gas transmission masks, particularly those used in home health care are held against a patient's face by a series of straps. Properly positioned straps can and are required to maintain correct mask position when a patient sleeps or engages in activities. For example, many varieties of Continuous Positive Airway Pressure (“CPAP”) masks are available which deliver air into a patient's airway under positive pressure while a patient sleeps. A CPAP mask may be used to treat conditions ranging form chronic sleep apnea to habitual snoring.

Typically, straps are held to a gas transmission mask by one of many varieties of clips. Ideally, the clips are easily removed from the mask structure itself so that the straps may be readily connected and disconnected by a patient when a mask is put on or taken off.

FIGS. 1 and 2 show one type of clip known in the prior art. Referring to FIG. 1, a prior art mask 10 is shown which features one or more attachment posts 12 associated with the body of the mask 10. The posts 12 in the embodiment depicted in FIG. 1 have a shaft 14 and a head 16 which features a larger cross-sectional dimension than the shaft 14. A prior art clip 18 is shown attached to the prior art mask in FIG. 1. A detailed plan view of the prior art clip 18 is also shown in FIG. 2.

The prior art clip 18 has a slot 20 appropriately sized to releasably secure an attachment strap. In addition, the prior art clip 18 features a keyhole opening 22 having a wide portion 24 and a narrow portion 26.

The wide portion 24 of the keyhole opening 22 of the prior art clip 18 will typically be sized to have a diameter which exceeds the cross-sectional dimension of the head 16 of the post 12. The narrow portion 26 of the keyhole opening 22 would typically be sized to have a diameter less than the cross-sectional dimension of the head 16, but equal to or slightly less than the cross-sectional dimension of the shaft 14. Thus, the prior art clip 18 could be attached to a mask 10 by placing the wide portion 24 of the keyhole opening 22 over the head 16 of a prior art post 12 and pulling laterally on the clip 18. Upon the application of sufficient lateral force, the shaft 14 could be made to snap fit into the narrow portion 26 of the keyhole opening 22, thus securing the clip and any associated strap to the mask 10. A strap could be removed by reversing these procedures.

Since a prior art clip as described above and shown in FIGS. 1 and 2 relied upon the rigidity of the keyhole opening to secure the clip 18 to the post 12, the clip was typically fabricated from a substantially rigid material such as a hard molded nylon. Accordingly, a great deal of force was necessary to snap the post from the wide portion 24 of the keyhole opening 22 to the narrow portion 26. A relatively greater degree of attachment force was particularly necessary if the prior art clip 18 was designed to be held securely. The lateral force necessary to attach or detach the clip could be especially problematic for very young and elderly mask users or those with weakened grip strength.

The present invention is directed toward overcoming one or more of the problems discussed above.

### SUMMARY OF THE INVENTION

One aspect of the present invention is a clip for receiving a post. The clip includes a body defining a hole having a diameter less than a select cross-section of the post. The body of the clip is made of a material which is sufficiently pliant to provide for the deformation of the hole to receive the post upon attachment or detachment of the clip to or from the post.

Another aspect of the present invention is a gas transmission mask including a post and a clip as described above for attaching a strap to the mask. The post may have a shaft and a head with a cross-sectional dimension of the head being greater than a cross-sectional dimension of the shaft. In addition, the hole may be substantially cylindrical. In this embodiment, the lengthwise axis of the cylindrical hole may be substantially equal in length to the length of the shaft.

The head of the post is typically located opposite the post's attachment to a mask. Typically the shaft will be cylindrical with the head being an expanded ball structure at one end of the shaft. However, the present invention is not limited to posts having this particular configuration. The clip may further include a slot defined by the body and sized to receive a strap.

The pliant body of the clip of any alternative embodiment the present invention may be made of a pliant thermoplastic such as synthetic rubber, silicone, thermoplastic resin, natural rubber or polyvinylchloride. The pliant body of the clip may be made of a material having a hardness of between 20-80 on the Shore “A” durometer scale.

Another aspect of the present invention is a method of attaching the clip to a gas transmission mask. The method includes providing a mask having both an attachment post as described above and a clip as described above. The method further includes attaching the clip to the post by axially inserting the post through the hole causing the pliant body of the clip to deform sufficiently to receive the post.

The hole of the clip utilized to implement the present method may be cylindrical and have a lengthwise axis substantially equal in length to the length of a shaft associated with the post. In such case the clip may be attached to the post by forcing the hole over the head causing the pliant body of the clip to deform sufficiently to receive the head allowing the head to pass through the hole such that the shaft is ultimately received within the cylindrical hole.

### BRIEF DESCRIPTION OF THE DRAWINGS

FIG. 1 is a perspective view of a prior art clip and mask;

FIG. 2 is a plan view of a prior art clip;

FIG. 3 is a perspective view of a mask and clip consistent with the present invention; and

FIG. 4 is a perspective view of a clip consistent with the present invention.

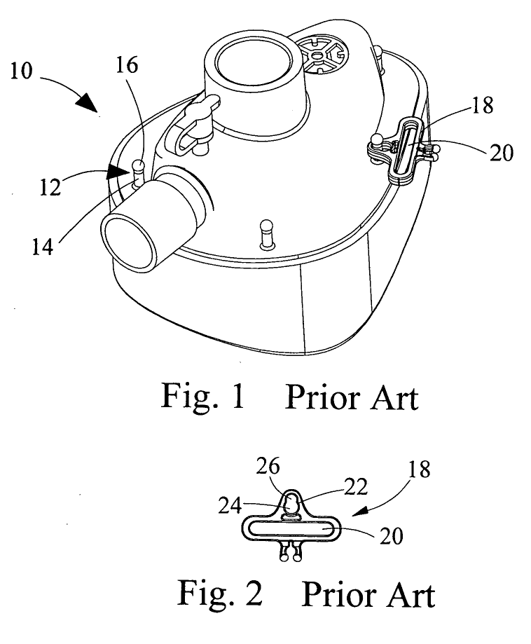

### DETAILED DESCRIPTION OF THE INVENTION

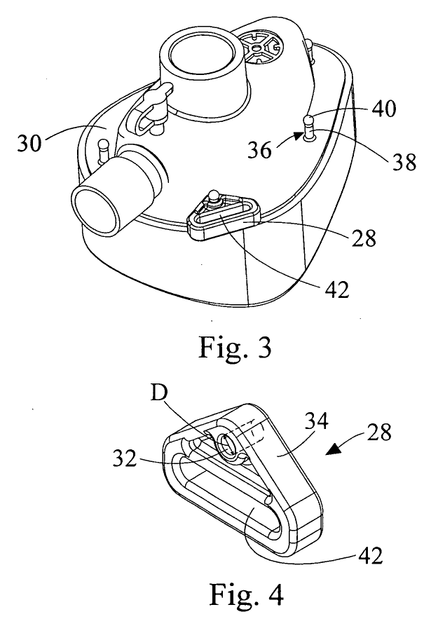

One aspect of the present invention as shown in FIG. 3 is a clip 28 useful for attaching a strap to a gas transmission mask 30. As used herein mask or gas transmission mask 30 refers to any mask type device suitable for placing a human patient's respiratory system in communication with an outside gas source. A representative mask 30 a CPAP mask.

The clip 28 of the present invention is shown in detail in FIG. 4. The clip 28 includes a hole 32 defined by the body 34 of the clip 28. The hole 32 has a diameter D as shown on FIG. 4. In addition, the body 34 of the clip 28 is made or fabricated of a material which is sufficiently pliant to provide for the deformation of the hole upon the application of reasonable manual force.

As is shown in FIG. 3, the clip 28 is configured to receive a post 36 when attached to a mask 30. The post 36 may include a substantially cylindrical shaft 38 and a head 40. As is also shown in FIG. 3, a cross-sectional dimension of the head 40 will typically be greater than a corresponding cross-sectional dimension of the shaft 38. However, the present invention is not limited to posts having this particular configuration.

The diameter D of the hole 32 will typically be less than a select cross-sectional dimension of the attachment post 36. As discussed above, the body 34 of the clip 28 will be made or fabricated from a material which is sufficiently pliant to allow the deformation of the hole to receive the post upon manual attachment of the clip to the post. In an embodiment where the post features a shaft 38 and a head 40, the diameter D may be less than a cross-sectional dimension of the head 40, but equal to or greater than a cross-sectional dimension of the shaft 38.

The clip 28 may further include a slot 42 sized to receive a strap. The hole 32 may be substantially cylindrical as is shown by phantom lines in FIG. 4. The axial length of the cylindrical hole 32 may be approximately equal to the axial length of the cylindrical shaft 38.

The clip 28 may feature a body made of any suitable pliant material. Pliant thermoplastics are readily available which could be used to implement a clip consistent with the present invention. For example, the body 34 of the clip 28 may be fabricated from materials including but not limited to: synthetic rubber, silicone, thermoplastic resin, natural rubber or polyvinylchloride. Applicant has determined that the clip will function appropriately as described herein if the body is manufactured from a material having a hardness rating of between 20-80 units on the Shore A durometer scale.

Another aspect of the present invention is a gas transmission mask 30 as shown in FIG. 3. The mask 30 features an attachment post 36 as described above, which may have shaft 38 and head 40 portions. The mask 30 also includes a clip 28 for receiving the post 36 as described above.

In use, multiple clips 28 will typically be associated with multiple posts 36 for any given mask 30. In addition, each clip 28 will be associated with a strap, typically with one clip 28 associated with each end of a particular strap. A strap may be attached to a mask 30 by simply forcing the hole 32 in the pliant body 34 of the clip 28 over the appropriate post 36. As the post 36 is axially inserted through the hole 38, the pliant material of the body 34 deforms sufficiently to receive the post 36. If the post 36 is configured as is shown in FIG. 3 with a shaft 38 and a head 40, the hole 32 may deform sufficiently to allow the head 40 to pass completely through the hole 32 providing for the hole 32 to be securely attached to the shaft 38. The clip may be removed from the post 36 by reversing the above-described steps. It is important to note that the pliant body 34 of the present clip 28 facilitates removal with any one of a relatively broad range of motions. For example, the clip may be removed by pulling it axially off of the post 36 in a complete reversal of the attachment motions. Alternatively, the clip 28 may be remove by rotating, twisting or leveraging it off of the post. Thus the pliant body 34 of the present clip 28 facilitates a much broader range of possible removal motions which in turn makes the clip 28 easier to attach and remove than prior art devices.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

What is claimed is:

1. A clip for receiving a post, the clip comprising a body defining a hole having a select diameter, the body being made of a material which is sufficiently pliant to provide for the deformation of the hole to receive the post upon axial insertion of the post into the hole.

2. The clip of claim 1 wherein the select diameter of the hole is less than a cross sectional dimension of a post head.

3. The clip of claim 1 further comprising a slot defined by the body to receive a strap.

4. The clip of claim 1 wherein the hole is cylindrical.

5. The clip of claim 1 wherein the body is made of a pliant thermoplastic.

6. The clip of claim 1 wherein the body is made of a material selected from a group consisting of synthetic rubber, silicone, thermoplastic resin, rubber and poly vinyl chloride.

7. The clip of claim 1 wherein the body is made of a material having a hardness of between 20 and 80 on the Shore A durometer scale.

8. A gas transmission mask comprising:
a post; and
a clip for receiving the post, the clip comprising a body defining a hole having a diameter less than a cross sectional dimension of the post, the body being made of a material which is sufficiently pliant to provide for the deformation of the hole to receive the post upon axial insertion of the post into the hole.

9. The gas transmission mask of claim 8 wherein the post comprises a shaft and a head and a cross sectional dimension of the head is greater than a cross sectional dimension of the shaft and the diameter of the hole is less than the cross sectional dimension of the head.

10. The gas transmission mask of claim 8 wherein the clip further comprises a slot defined by the body to receive a strap.

11. The gas transmission mask of claim 8 wherein the hole is cylindrical.

12. The gas transmission mask of claim 8 wherein the body is made of a pliant thermoplastic.

13. The gas transmission mask of claim 8 wherein the body is made of a material selected from a group consisting of synthetic rubber, silicone, thermoplastic resin, rubber and poly vinyl chloride.

14. The gas transmission mask of claim 8 wherein the body is made of a material having a hardness of between 20 and 80 on the Shore A durometer scale.

15. The gas transmission mask of claim 11 wherein a lengthwise axis of the cylindrical hole is substantially equal in length to a length of the shaft.

16. A method of attaching a clip to a gas transmission mask comprising:
providing a mask having an attachment post;
providing a clip comprising a pliant body defining a hole having a diameter less than a cross sectional dimension of the post; and
attaching the clip to the post by forcing the hole over the post axially, causing the pliant body to deform sufficiently to receive the post.

17. The method of attaching a clip to a gas transmission mask of claim 16 wherein the post comprises a shaft and a head and a cross sectional dimension of the head is greater than a cross sectional dimension of the shaft and the diameter of the hole is less than the cross sectional dimension of the head, and the clip is attached to the post by forcing the hole over the head axially, causing the pliant body to deform sufficiently to receive the head.

18. The method of attaching a clip to a gas transmission mask of claim 17 wherein the hole is cylindrical and has a lengthwise axis substantially equal in length to the length of the shaft and the clip is attached to the post by forcing the hole over the head causing the pliant body to deform sufficiently to receive the head and the shaft is received within the cylindrical hole.
